(19) United States
(12) Patent Application Publication
(10) Pub. No.: US 2014/0337297 A1
(43) Pub. Date: Nov. 13, 2014

(54) SYSTEM AND METHOD FOR MARINE DEBRIS MANAGEMENT

(71) Applicant: Marine Debris Management Systems, LLC, Daphne, AL (US)

(72) Inventors: James HERNDON, Daphne, AL (US); Matthew JONES, Corpus Christie, TX (US)

(73) Assignee: Marine Debris Management Systems, LLC, Daphne, AL (US)

(21) Appl. No.: 14/253,273

(22) Filed: Apr. 15, 2014

Related U.S. Application Data
(60) Provisional application No. 61/811,923, filed on Apr. 15, 2013.

(51) Int. Cl. G06F 17/30

(52) U.S. Cl. CPC G06F 17/30943
USPC 707/687

(57) ABSTRACT

Authenticating marine debris prior to recovery by: generating SONAR signal data related to the bottom of a body of water; processing the data to identify the presence or absence of debris targets; generating an image of the objects detected; storing the image in an assessment database; associating each image stored in the assessment database with position information and dimensions of that debris target; generating a side scan sonar report including an image of debris target detected on the ocean or lake floor, object position and dimension data; transmitting the sonar report to an offsite or on site debris image processor for identification of the target; comparing the target reported in the sonar report with a database to determine whether the target object is storm debris; transmitting a signal to ship for target pickup if it is determined that the target object is a storm debris object. The system and method further includes verification where upon recovering and imaging the target object or the target site post recovery; the image is processed and compared with the authentication database.

### CROSS-REFERENCE TO RELATED APPLICATIONS

This application claims priority to Provisional Application 61/811,923 titled “System and Method for Marine Debris Management” filed on Apr. 15, 2013 which is incorporated herein, in its entirety, by this reference.

### FIELD OF THE INVENTION

The present invention generally relates to management and recovery of marine waste. More particularly, the present invention relates to a system and method for the identification, verification and recovery of marine debris.

### BACKGROUND OF THE INVENTION

Hurricanes and storms cause devastation to the infrastructure and livelihoods of residents along coastal regions. A majority of damage that occurs has a profound impact on people dependent upon a state's commercial and recreational fisheries. In particular, a strong storm ravages and impacts, and in some cases demolishes, habitat for humans and wildlife causing a loss of recreational and commercial boats and gear, homes, automobiles and personal property, as well as industrial structures and supplies. The ocean bed along the shores where these storms strike has become the resting place for a large and unknown collection of this storm debris. The storms also displace artificial and natural debris such as containers, boats, goods and vegetation. Artificial debris left derelict from the storm deteriorate and create fields of marine debris.

Conventional techniques of recovering debris off the ocean floor or lake floor include detection of the debris, lifting the debris from a seabed or lake bed to water surface one at a time, and identification of the debris at the shore. However, such techniques of recovering marine debris are time consuming and expensive. Further, federal or state contracts for recovering storm debris require that only objects designated as storm displaced objects be recovered. In addition, there can be areas that are deemed sensitive due to for example environmental or historical reasons, where storm debris is not to be removed. To diminish potential for fraud there is also a need for a system that can confirm that the appropriate storm debris is indeed removed and/or that all necessary storm debris is indeed removed.

In order to track all of the moving parts of a large-scale debris management operation, the United States Army Corps of Engineers (USACE) prefers automated debris management systems (ADMS) meeting specific characteristics. Amongst other features, ADMS creates load tickets electronically, thereby eliminating the need for hand written and scanned tickets.

While ADMS systems exist for ground debris removal, there remains a need for an ADMS system for below water debris removal. That is, a need exists for a system and method for detecting and identifying marine debris on ocean or lake floor, ascertaining which identified objects are to be removed and verifying the removal. Such system and method must be in compliance with performance characteristics set by USACE.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a system and method for detecting and identifying marine debris on the ocean or lake floor, ascertaining which target objects are to be removed, and verifying the removal. In one embodiment detecting and identifying marine debris includes generating sonar signal data of the ocean or lake floor; recording sonar signal data in an assessment database; analyzing the assessment database to identify the presence or absence of debris on the ocean or lake floor; generating an image of the object detected; storing the image in the assessment database; associating each image stored in the assessment database with position information and dimensions of that debris object; generating a side scan sonar report including an image of debris object detected on the ocean or lake floor, object position and dimension data; transmitting the sonar report to debris image processor for identification of the target object; and comparing target object reported in the sonar report with a database such as a debris verification database to determine whether the target object is storm debris. In one embodiment the debris image processor is located on the shore. In one embodiment this acquired information is sent for authentication. Authentication can include for example environmental or historical review. A signal is then transmitted to the reclamation ship providing information for target pickup/recover. Upon recovery either the recovered object is imaged or the location from where the target was removed is imaged. This image is processed and added to the data site for the particular target location.

It is an object of the present invention to provide an automated debris management systems (ADMS) for under water debris recovery that meets United States Army Corps of Engineers (USACE) requirements.

It is a further object to provide a means of verifying whether or not only authenticated targets have been removed and whether or not all authenticated targets have been removed.

It is a further object to provide a method and system for authenticating marine debris prior to recovery from ocean or lake floor including steps such as: obtaining SONAR data related to the bottom of a body of water; processing the SONAR data to create processed SONAR data and to identify targets; obtaining position data related to the targets; populating an assessment database with the processed SONAR data, targets, and position data; providing a first time stamp to the assessment database; providing the assessment database to an off-site location for authentication; augmenting the assessment database with authentication data to create an authentication database having at least one authenticated target residing at an authenticated target site; providing a second time stamp to the authentication database; and providing the authentication database to a removal ship, where based upon the authentication database the removal ship recovers the authenticated target from the authenticated target site.

It is a further object to provide a method of verifying marine debris recovery including the following steps: obtaining SONAR data related to the bottom of a body of water; processing the SONAR data to create processed SONAR data and to identify targets; obtaining position data related to the targets; populating an assessment database with the processed SONAR data, targets, and position data; providing a first time stamp to the assessment database; providing the assessment database to an off-site location for authentication; augmenting the assessment database with authentication data to create an authentication database having at least one authenticated target residing at an authenticated target site; providing a second time stamp to the authentication database; providing the authentication database to a removal ship, wherein based upon the authentication database said removal ship recovers the authenticated target from an authenticated target site; obtaining image recovery data, the image recovery data being at least one of an image of a recovered authenticated target or an image of the authenticated target site following the removal of the recovered authenticated target; augmenting said authentication database with image recovery data to create a recovery database; providing a third time stamp to the recovery database; comparing the recovery database with the authentication database and storing the results in a verification database; and providing a fourth time stamp to the verification database.

It is a further object to provide an integrated data system including an assessment database, an authentication database, a recovery database, and a verification database.

### BRIEF DESCRIPTION OF DRAWINGS

FIG. 1 illustrates an exemplary system for identifying marine debris on ocean or lake floor.

FIG. 2 illustrates an exemplary towed array sonar system that is used in embodiment of the present invention.

FIG. 3 illustrates an exemplary method in accordance with an embodiment of the present invention for identifying marine debris on ocean or lake floor.

FIG. 4 illustrates an exemplary side scan sonar report of debris object detected on the ocean floor.

### DETAILED DESCRIPTION

At the highest level, the removal of marine debris from the ocean or lake floor in accordance with the present invention includes assessment, authentication, removal and verification.

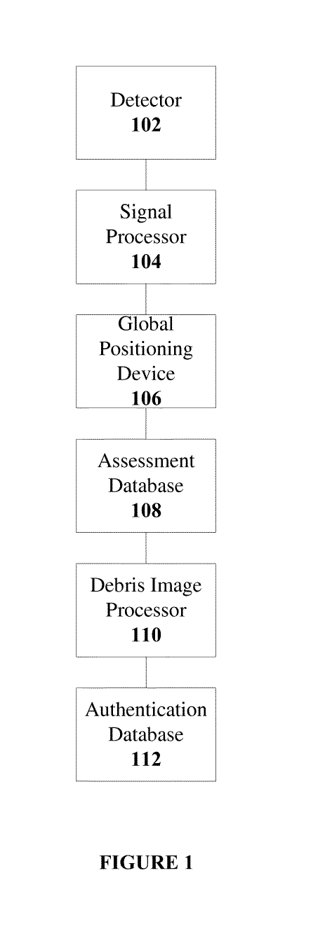

Referring now to the drawings, and more particularly, to FIG. 1, there is shown a system for assessing the presence of marine debris on the ocean or lake floor and authenticating targets for removal, generally designated 100. System 100 includes detector 102, signal processor 104, global positioning device 106, an assessment database 108, debris image processor 110, and authentication database 112.

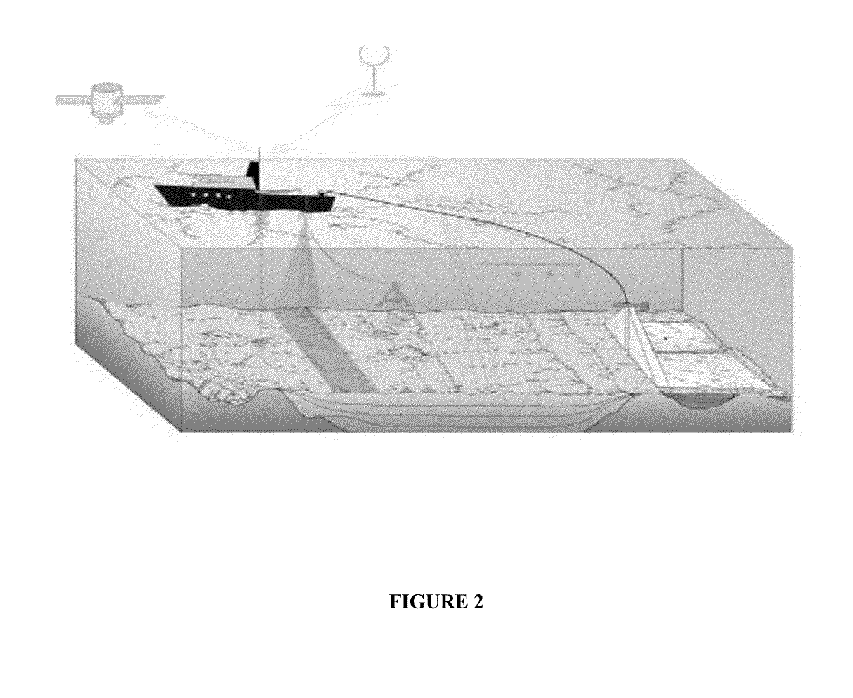

Detector 102 can be a conventional towed array sonar system having a towed array (“sonar fish”) that includes a towing cable, an acoustically active section with hydrophones or electro-acoustic transducers, and an end section for stabilizing the position and alignment of the towed array in the water, such as shown in FIG. 2. Such a system is also know as side scan SONAR. On surface ships, such towed arrays are installed at the stern of the ship and deployed into the surrounding body of water, as well as subsequently retrieved, by means of a winch that is mounted at the stern for this purpose. The sonar fish actively emits sound waves, which are then recorded with the acoustically active section of the towed array, e.g., after they were reflected on the bottom of the body of water, and sonar data is determined from the recorded sound waves aboard the ship.

Signal-processing device 104 is connected to the towed array and processes the obtained sonar data in order to provide a report on objects found on the ocean or lake floor. In one example the signal-processing device is SONARWIZ available through Chesapeake Technology. This type of tool combines sidescan, sub-bottom, bathymetry and magnetometer mapping software for data acquisition and post processing

At least one control console for operating and controlling the towed array sonar system, and a positioning device 106 for mapping the determined position is arranged aboard the ship. In one embodiment the positioning device is GPS.

Processed sonar data from signal-processing device 104 and associated position data from positioning device 106 is recorded in assessment database 108. The assessment database thus includes for example identified targets with descriptors. The descriptors can include for example dimensions, coordinates (locations), related images, whether the target could comprise hazardous materials (HAZMAT), and the like. The assessment database can be viewed and one can run customized reports based upon descriptors. In one example, ARCGIS is used to visually represent the field-integrated database as a map (e.g. an ARCMAP). ARCGIS is available through ESRI. Similar mapping systems are available and known by one of skill in the art. The assessment database and/or map can be made available by way of a web site, a secure server, or the like.

The assessment database can then be forwarded/sent to one or more sites for authentication. The determination as to which targets are to be targeted for removal can be dependent upon factors such as budget, environmental site concerns, historical site concerns, and the like. Thus, target review can include individuals within FEMA as well as third parties such as environmentalists, archeologists, and the like. Considerations can include the creation of buffer zones. The assessment database and/or the assessment map is then modified to indicate authenticated targets, thereby creating the authentication database and/or an authentication map.

The authentication database and/or map including authenticated targets is then sent to the debris/target removal team. As a debris/target is recovered either the debris or the related target site is photographed. In one embodiment an application can be created such that the photograph is via a PDA with option to add data such as vessel name, captain name, coordinates, time of day and the like. The authentication database and/or map is then augmented to include this photographic and identification data to create a removal database.

Once the debris/target is recovered and either the debris/target or the related site is photographed, debris image processor 110 processes the image and compares the processed image with stored information in the authentication database and/or map 112. This comparison provides verification that the appropriate authenticated target was removed. The removal database is augmented with this process post image to create a verification database.

Through this process a marine debris recovery verification database is created. The marine debris recovery verification database includes each of the assessment database, the authentication database, the removal database and the verification database. The marine debris recovery verification database includes records for each target. These records include for example: the original descriptors related to identified targets such as image, location, and size; authentication of target; image and location data from retrieval of the target; and verification of removal. Based upon the debris recovery verification database one can confirm that all eligible targets in an area have been removed. Similarly, based upon the debris recovery verification database one can confirm that only eligible targets have been removed as storm debris. In one embodiment reimbursement is tied to clearance via the debris recovery verification database.

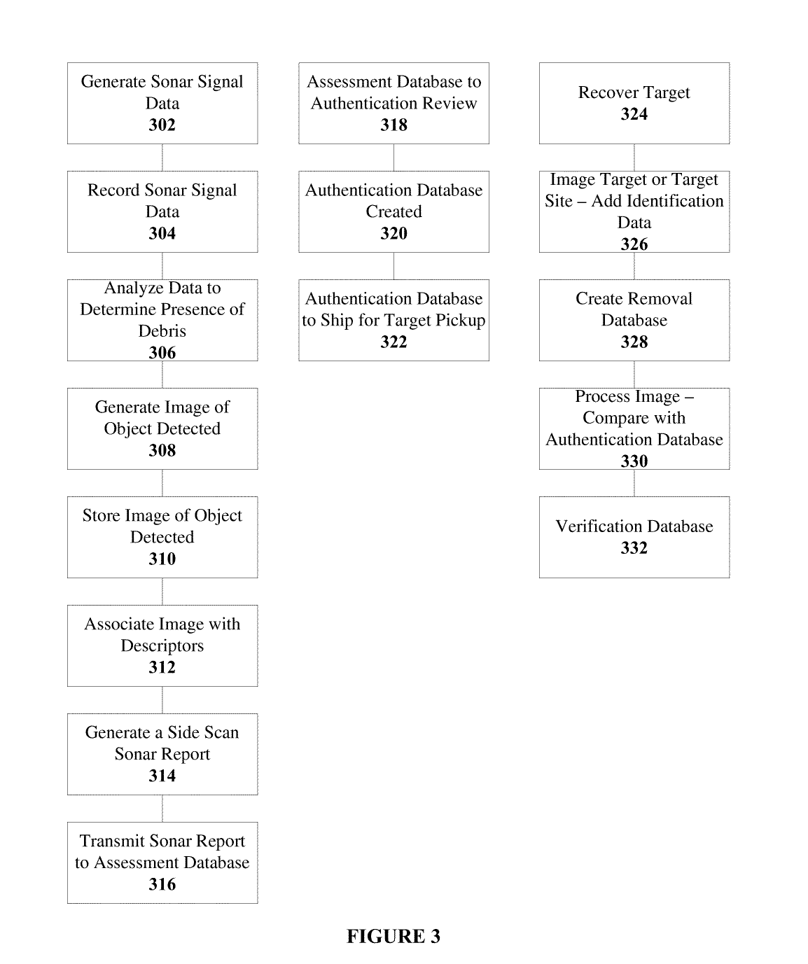

FIG. 3, generally at 300, shows an exemplary method in accordance with an embodiment of the present invention. At step 302, detector 102 generates sonar signal data of the ocean or lake floor. This sonar signal data is recorded at step 304 in the assessment database 108. At step 306, sonar data is analyzed to identify the presence or absence of debris on the ocean or lake floor. Analysis of sonar data includes measurement of sediments around the object detected, determining dimensions of the object, and the like. At step 308, signal-processing device 104 generates an image of the object detected and stores the image in assessment database 108 at step 310. Each image stored in assessment database 108 is associated with position information generated by positioning device 106 for that particular debris object and dimensions of the object. At step 312 additional descriptor information related to the object can also be incorporated including for example object position and dimension data. A side scan sonar report can be generated at step 314, which includes an image of the debris object detected on the ocean or lake floor.

At step 316, the sonar report and related information is added to the assessment database. At step 318, the assessment database is reviewed for authentication of targets. At this stage the target objects reported in the varying sonar reports included within the assessment database are analyzed to determine whether the target object is storm debris and whether the target object should be removed. If the target object is not storm debris and/or if the target object should not be removed, system 100 moves to the identification of the next target. If the target object is storm debris object, then the assessment database is revised creating an authentication database (step 320). At step 322 the authentication database is sent to the ship to identify targets for pickup. Alternatively, a signal is transmitted to ship for a specific target object pickup. At step 324 target is recovered. At step 326 either target or the related target site is imaged. Identification data is added. Both the image and identification data are added to the authentication database in step 328 creating a removal database. In step 330 the image is processed and compared with the authentication database. In step 332 this comparison data is added to the removal database creating a verification database.

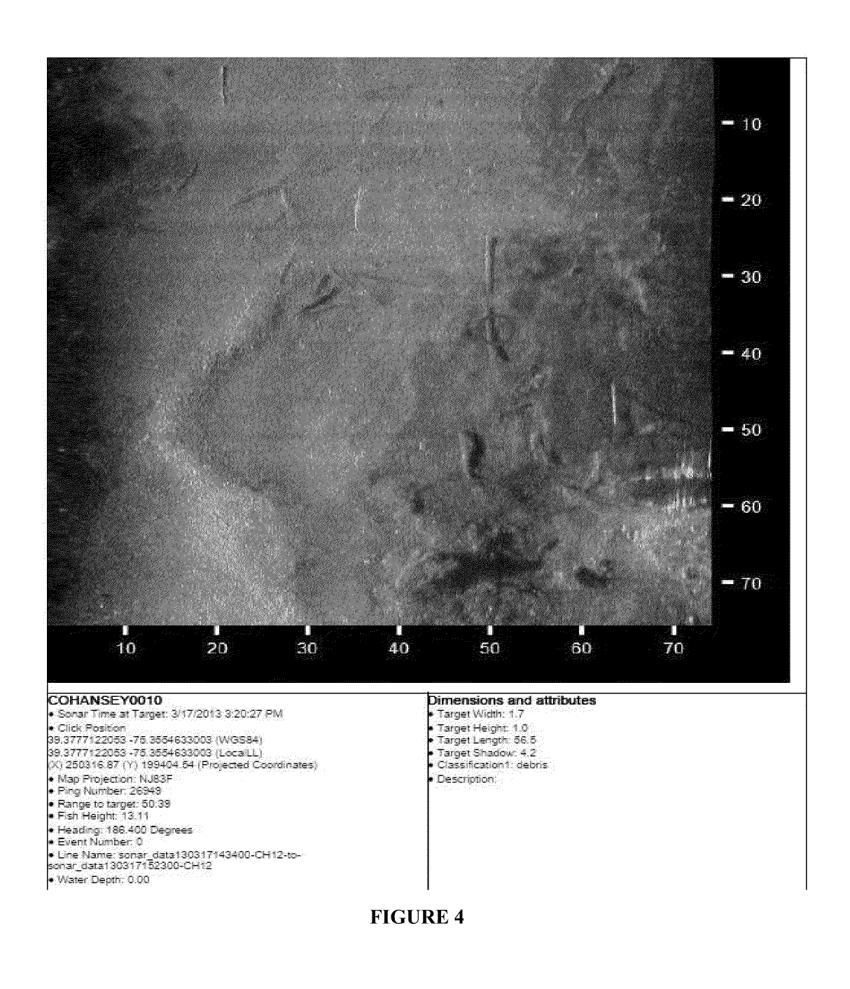

FIG. 4 illustrates an exemplary side scan sonar report including an image of debris object detected on the ocean or lake floor, object position and dimension data.

In one embodiment the assessment database, authentication database, recovery database, and verification database form an integrated information system that can be secure from further revision and is searchable.

TABLE 1 below provides an exemplary listing of debris verified as removed storm debris (e.g. removed targets). In one embodiment this listing can include name of target, field data, SONAR latitude, SONAR longitude, a SONAR image, SONAR number, target picture, ticket image, removal date, removal latitude, removal longitude, image of either item removed or site from which it was removed, and object shape.

TABLE 1

| | FID_{—} | Target | Field2 | Field3 | Sonar_Latitude | Sonar_Longi [symbol] | Sonar_Image | Sonar | Debris_Pic | Ticket_ID | Ticket_Image |
|---|---|---|---|---|---|---|---|---|---|---|---|
| | <Null> | MAURICE_RIVER0481 | 353276.775 | 170357.822 | 39.3007 | 74.990673 | C:\Users\The Man\ | 3331 | 1254 | 1234 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0482 | 352986.417 | 170540.256 | 39.300566 | 74.991703 | C:\Users\The Man\ | 3331 | 1254 | 1235 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0483 | 353134.42 | 170486.039 | 39.30042 | 74.991179 | C:\Users\The Man\ | 3331 | 1254 | 1236 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| [symbol] | <Null> | MAURICE_RIVER0484 | 353078.23 | 170607.239 | 39.300752 | 74.99138 | C:\Users\The Man\ | 3331 | 1254 | 1237 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0485 | 352929.947 | 170632.146 | 39.300818 | 74.991904 | C:\Users\The Man\ | 3331 | 1254 | 1238 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0486 | 352837.092 | 170755.87 | 39.301156 | 74.992235 | C:\Users\The Man\ | 3331 | 1254 | 1239 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0487 | 353077.563 | 171090.249 | 39.302078 | 74.991391 | C:\Users\The Man\ | 3331 | 1254 | 1240 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0488 | 352872.132 | 171147.175 | 39.302231 | 74.992118 | C:\Users\The Man\ | 3331 | 1254 | 1241 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0489 | 353157.351 | 171466.148 | 39.303111 | 74.991117 | C:\Users\The Man\ | 3331 | 1254 | 1242 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0490 | 353270.653 | 171563.028 | 39.303379 | 74.990718 | C:\Users\The Man\ | 3331 | 1254 | 1243 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0491 | 353285.98 | 171524.199 | 39.303272 | 74.990663 | C:\Users\The Man\ | 3331 | 1254 | 1244 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0492 | 353517.549 | 171900.803 | 39.30431 | 74.989852 | C:\Users\The Man\ | 3331 | 1254 | 1245 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0493 | 353330.717 | 171993.559 | 39.304562 | 74.990514 | C:\Users\The Man\ | 3331 | 1254 | 1246 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0495 | 353775.958 | 172266.083 | 39.305317 | 74.988946 | C:\Users\The Man\ | 3331 | 1254 | 1247 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0496 | 353978.004 | 172533.279 | 39.306053 | 74.988237 | C:\Users\The Man\ | 3331 | 1254 | 1248 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0498 | 353263.99 | 173510.909 | 39.308727 | 74.990779 | C:\Users\The Man\ | 3331 | 1254 | 1249 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0499 | 353083.073 | 173590.316 | 39.308942 | 74.99142 | C:\Users\The Man\ | 3331 | 1254 | 1250 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0500 | 351668.219 | 172976.152 | 39.307235 | 74.996408 | C:\Users\The Man\ | 3331 | 1254 | 1251 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0501 | 351955.965 | 172727.535 | 39.306556 | 74.995387 | C:\Users\The Man\ | 3331 | 1254 | 1252 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0502 | 351815.201 | 172741.928 | 39.306594 | 74.995884 | C:\Users\The Man\ | 3331 | 1254 | 1253 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0503 | 350472.915 | 173826.849 | 39.309552 | 75.000649 | C:\Users\The Man\ | 3331 | 1254 | 1254 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0504 | 350453.585 | 173914.449 | 39.309792 | 75.000719 | C:\Users\The Man\ | 3331 | 1254 | 1255 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0505 | 350063.93 | 174320.923 | 39.310902 | 75.002105 | C:\Users\The Man\ | 3331 | 1254 | 1256 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0506 | 350300.083 | 174932.086 | 39.312584 | 75.001282 | C:\Users\The Man\ | 3331 | 1254 | 1257 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0507 | 350623.751 | 174989.4 | 39.312746 | 75.000139 | C:\Users\The Man\ | 3331 | 1254 | 1258 | C:\Users\The Man\Desktop\ |
| | | | | | | | Desktop\DEMO\ | | | | DEMO\Ticket1.pdf |
| | | | | | | | B [symbol] DWELL_CREEK0030.JPG | | | | |
| | <Null> | MAURICE_RIVER0508 | 350697.776 | 175087.836 | 39.313018 | 74.999879 | C:\Users\The Man\ | 3331 | 1254 | 1259 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0509 | 350716.606 | 175093.636 | 39.313034 | 74.999813 | C:\Users\The Man\ | 3331 | 1254 | 1260 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0510 | 350879.287 | 175256.145 | 39.313483 | 74.999241 | C:\Users\The Man\ | 3331 | 1254 | 1261 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0525 | 351372.429 | 175765.07 | 39.314887 | 74.997508 | C:\Users\The Man\ | 3331 | 1254 | 1262 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0529 | 351372.319 | 176075.838 | 39.315741 | 74.997514 | C:\Users\The Man\ | 3331 | 1254 | 1263 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0535 | 351302.026 | 176972.385 | 39.318201 | 74.99778 | C:\Users\The Man\ | 3331 | 1254 | 1264 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0545 | 350922.891 | 177532.727 | 39.319734 | 74.999131 | C:\Users\The Man\ | 3331 | 1254 | 1265 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0553 | 349215.545 | 177709.325 | 39.320193 | 75.00517 | C:\Users\The Man\ | 3331 | 1254 | 1266 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0562 | 349481.35 | 178873.44 | 39.323393 | 75.004253 | C:\Users\The Man\ | 3331 | 1254 | 1267 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0566 | 349465.087 | 179048.018 | 39.323872 | 75.004314 | C:\Users\The Man\ | 3331 | 1254 | 1268 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |
| | <Null> | MAURICE_RIVER0577 | 349956.949 | 179740.122 | 39.32578 | 75.002589 | C:\Users\The Man\ | 3331 | 1254 | 1269 | C:\Users\The Man\Desktop\ |
| | | | | | | | Desktop\DEMO\ | | | | DEMO\Ticket1.pdf |
| | | | | | | | B [symbol] DWELL_CREEK0017.JPG | | | | |

| | FID_{—} | Target | Removal_Date | Removal_Lati [symbol] | Removal_Longi [symbol] | Removal_Debris_Image | Shape [symbol] |
|---|---|---|---|---|---|---|---|
| | <Null> | MAURICE_RIVER0481 | Apr. 1, 2013 | 0 | 0 | C:\Users\The Man\Desktop\DEMO\TREE_DEBRIS.jpg | Point |
| | <Null> | MAURICE_RIVER0482 | Apr. 2, 2013 | 0 | 0 | C:\Users\The Man\Desktop\DEMO\TREE_DEBRIS.jpg | Point |
| | <Null> | MAURICE_RIVER0483 | Apr. 3, 2013 | 0 | 0 | C:\Users\The Man\Desktop\DEMO\TREE_DEBRIS.jpg | Point |
| [symbol] | <Null> | MAURICE_RIVER0484 | Apr. 4, 2013 | 0 | 0 | C:\Users\The Man\Desktop\DEMO\TREE_DEBRIS.jpg | Point |
| | <Null> | MAURICE_RIVER0485 | Apr. 5, 2013 | 0 | 0 | C:\Users\The Man\Desktop\DEMO\TREE_DEBRIS.jpg | Point |
| | <Null> | MAURICE_RIVER0486 | Apr. 6, 2013 | 0 | 0 | C:\Users\The Man\Desktop\DEMO\TREE_DEBRIS.jpg | Point |
| | <Null> | MAURICE_RIVER0487 | Apr. 7, 2013 | 0 | 0 | C:\Users\The Man\Desktop\DEMO\TREE_DEBRIS.jpg | Point |
| | <Null> | MAURICE_RIVER0488 | Apr. 8, 2013 | 0 | 0 | C:\Users\The Man\Desktop\DEMO\TREE_DEBRIS.jpg | Point |
| | <Null> | MAURICE_RIVER0489 | Apr. 9, 2013 | 0 | 0 | C:\Users\The Man\Desktop\DEMO\TREE_DEBRIS.jpg | Point |
| | <Null> | MAURICE_RIVER0490 | Apr. 10, 2013 | 0 | 0 | C:\Users\The Man\Desktop\DEMO\TREE_DEBRIS.jpg | Point |
| | <Null> | MAURICE_RIVER0491 | Apr. 11, 2013 | 0 | 0 | C:\Users\The Man\Desktop\DEMO\TREE_DEBRIS.jpg | Point |
| | <Null> | MAURICE_RIVER0492 | Apr. 12, 2013 | 0 | 0 | C:\Users\The Man\Desktop\DEMO\TREE_DEBRIS.jpg | Point |
| | <Null> | MAURICE_RIVER0493 | Apr. 13, 2013 | 0 | 0 | C:\Users\The Man\Desktop\DEMO\TREE_DEBRIS.jpg | Point |
| | <Null> | MAURICE_RIVER0495 | Apr. 14, 2013 | 0 | 0 | C:\Users\The Man\Desktop\DEMO\TREE_DEBRIS.jpg | Point |
| | <Null> | MAURICE_RIVER0496 | Apr. 15, 2013 | 0 | 0 | C:\Users\The Man\Desktop\DEMO\TREE_DEBRIS.jpg | Point |
| | <Null> | MAURICE_RIVER0498 | Apr. 16, 2013 | 0 | 0 | C:\Users\The Man\Desktop\DEMO\TREE_DEBRIS.jpg | Point |
| | <Null> | MAURICE_RIVER0499 | Apr. 17, 2013 | 0 | 0 | C:\Users\The Man\Desktop\DEMO\TREE_DEBRIS.jpg | Point |
| | <Null> | MAURICE_RIVER0500 | Apr. 18, 2013 | 0 | 0 | C:\Users\The Man\Desktop\DEMO\TREE_DEBRIS.jpg | Point |
| | <Null> | MAURICE_RIVER0501 | Apr. 19, 2013 | 0 | 0 | C:\Users\The Man\Desktop\DEMO\TREE_DEBRIS.jpg | Point |
| | <Null> | MAURICE_RIVER0502 | Apr. 20, 2013 | 0 | 0 | C:\Users\The Man\Desktop\DEMO\TREE_DEBRIS.jpg | Point |
| | <Null> | MAURICE_RIVER0503 | Apr. 21, 2013 | 0 | 0 | C:\Users\The Man\Desktop\DEMO\TREE_DEBRIS.jpg | Point |
| | <Null> | MAURICE_RIVER0504 | Apr. 22, 2013 | 0 | 0 | C:\Users\The Man\Desktop\DEMO\TREE_DEBRIS.jpg | Point |
| | <Null> | MAURICE_RIVER0505 | Apr. 23, 2013 | 0 | 0 | C:\Users\The Man\Desktop\DEMO\TREE_DEBRIS.jpg | Point |
| | <Null> | MAURICE_RIVER0506 | Apr. 24, 2013 | 0 | 0 | C:\Users\The Man\Desktop\DEMO\TREE_DEBRIS.jpg | Point |
| | <Null> | MAURICE_RIVER0507 | Apr. 25, 2013 | 0 | 0 | C:\Users\The Man\Desktop\DEMO\TREE_DEBRIS.jpg | Point |
| | <Null> | MAURICE_RIVER0508 | Apr. 26, 2013 | 0 | 0 | C:\Users\The Man\Desktop\DEMO\BOAT.jpg | Point |
| | <Null> | MAURICE_RIVER0509 | Apr. 27, 2013 | 0 | 0 | C:\Users\The Man\Desktop\DEMO\BOAT.jpg | Point |
| | <Null> | MAURICE_RIVER0510 | Apr. 28, 2013 | 0 | 0 | C:\Users\The Man\Desktop\DEMO\BOAT.jpg | Point |
| | <Null> | MAURICE_RIVER0525 | Apr. 29, 2013 | 0 | 0 | C:\Users\The Man\Desktop\DEMO\BOAT.jpg | Point |
| | <Null> | MAURICE_RIVER0529 | Apr. 30, 2013 | 0 | 0 | C:\Users\The Man\Desktop\DEMO\BOAT.jpg | Point |
| | <Null> | MAURICE_RIVER0535 | May 1, 2013 | 0 | 0 | C:\Users\The Man\Desktop\DEMO\BOAT.jpg | Point |
| | <Null> | MAURICE_RIVER0545 | May 2, 2013 | 0 | 0 | C:\Users\The Man\Desktop\DEMO\BOAT.jpg | Point |
| | <Null> | MAURICE_RIVER0553 | May 3, 2013 | 0 | 0 | C:\Users\The Man\Desktop\DEMO\BOAT.jpg | Point |
| | <Null> | MAURICE_RIVER0562 | May 4, 2013 | 0 | 0 | C:\Users\The Man\Desktop\DEMO\BOAT.jpg | Point |
| | <Null> | MAURICE_RIVER0566 | May 5, 2013 | 0 | 0 | C:\Users\The Man\Desktop\DEMO\BOAT.jpg | Point |
| | <Null> | MAURICE_RIVER0577 | May 6, 2013 | 0 | 0 | C:\Users\The Man\Desktop\DEMO\BOAT.jpg | Point |

[symbol]

indicates data missing or illegible when filed

System and method in accordance with embodiments of the present invention can be used to identify, assess, authenticate, record, validate and quantify wet debris targets collected by side-scan sonar in an automated manner. Embodiments of the present invention enable determination of wet debris targets in an inexpensive and less time consuming manner, and is further suited for implementation with federally reimbursed projects. It allows for implementation of such projects with less margin of error, and allows qualified personnel to make better decisions regarding eligibility of targets as storm debris.

The system and method of the present invention meet USACE ADMS requirements, including performance characteristics such as the below.

The system can generate an electronic load ticket at the time of loading debris into a transport container such as a ship. Alternatively, the system can generate both a paper load ticket and an electronic load ticket. The system generating the load ticket allows creation of point of origin load data only when the position is known and credentials have been authenticated. The system automatically records date and time and other relevant point of origin data. The system writes point of origin load data using encrypted storage algorithms. The system can record right of entry or work order number. The system documents ticket/tower personnel credentials with point of origin load data. The system further acknowledges successful data capture. The system records digital images of debris, location, and/or other images selected by user.

The system can provide duplicate databases for internet and government use.

The need for manual entry is reduced in the system of the present invention. In at least one embodiment only two elements of the traditional debris paper load ticket (debris type and load call) are manually entered.

The system of the present invention uses global positioning system (GPS) and geographic information system (GIS) technologies to automatically determine the most direct haul route from loading site to disposal site. In alternate embodiments mileage can be recorded.

Evaluation of daily event status, production information, and performance information can be provided in conjunction with the present invention using web-based reporting, off the shelf software, and GIS tools.

Coordination of contractor invoices, Federal Emergency Management Agency (FEMA) documentation and applicant payment processes can be enabled thru an integrated database management system in conjunction with the present invention.

Ticket/tower applications can include for example: ticket/tower monitor electronic registration; generate, document, track, and manage unique encrypted identification data for employed personnel; link designated ticket/tower personnel roles to a specific mission; the ability to edit ticket/tower personnel roles i.e., create, update and delete; assign and track equipment used in debris hauling and reduction; store ticket/tower personnel contact information relative to the mission; track and manage ticket/tower personnel role and status; reject invalid ticket/tower personnel credentials; and reject invalid certification credentials.

Certification can be used to register authorized debris hauling vehicles (such as ships) and equipment. This can include for example: a means of electronically registering authorized debris contractor vehicles and equipment; link electronic registration to digital images; identify mission and governmental entity; document and record unique identification data for contractor vehicles and equipment; utilize uniform measurements e.g. feet and inches; capture vehicle volume; utilize industry standard equations for all volume calculations; capture captains and certification team member unique identification number; recertify vehicles; recertified vehicles are recorded in an audit table; certification data is be associated to authorized system user; reject vehicles that are not associated with current event and applicant; capture vehicle audit records; create a printed certification record; and; administrative reporting capabilities.

In at least one embodiment of use in conjunction with the present invention completed rights of way (ROW), rules of engagement (ROE) and Per-unit point of origin transactions are received at the approved disposal site. In at least one embodiment the disposal site management application provides the capability to: accept site configuration data at the beginning of each work day; dynamically configure receiving application based on site configuration data; display certification data and photo for ticket/tower personnel to perform a field audit of vehicle to assure they match certification and placard number; designate debris type; record debris volume (based on unit of measure for the contract task order); identify original load data and create hard copy; create load data record in internal storage; create backup copy of internal storage; continuously calculate and present real-time disposal site statistics; re-print load ticket data; preserve in its original state, then transmit daily transaction data; associate ticket/tower personnel credentials with each received load.

In at least one embodiment the present system used alone and/or used in conjunction with land based systems performs administrative duties, verifies vehicle audit information, displays real-time collection volumes, and reviews ticket/tower personnel GPS audit logs. The field administrative applications can provide the capability to: change ticket/tower personnel identification roles and responsibilities; review total CY counter value; audit vehicle certification data; validate/invalidate equipment and personnel; reinitiate security sequence for ticket/tower personnel; in tabular format, and display the results of ticket/tower GPS audit files by limiting access to the internet data or by the government secure server.

In at least one embodiment the present system used alone and/or used in conjunction with land based systems provides a means to summarize, validate, present, and audit transactional data to provide an overall status of mission performance. The data consolidation applications facilitate billing, error reporting, performance tracking and graphical data preparation. The data consolidation tools provide the capability to: accept transactional data sets from multiple debris location systems; recognize multiple mission/applicant configurations; grant access to authorized authenticated users or processes; contain a master record; thematic mapping techniques to distinguish different data by color and/or symbol; identify data attributes for a single point of data; select one or many points of data; calculate operational efficiency statistics such as trip turnaround time, trip distance to disposal site (straight line projection), average container fill percentage, average tower manager load call, load call trend data (e.g., by tower managers, contractor, sub contractor, driver, etc.); multiple data selections generate tabular data reports; filter mechanisms to highlight geospatial data; role based security; prevent distributed data from being reprocessed for billing purposes; identify billing data sets based on parameters such as Time/Date, Contractor/Subcontractor, Debris type, Debris disposal method (haul-in, reduction, open burn, incineration, haul-out, leave in place, etc.), haul distance; prevent modification to original data by unauthorized or unauthenticated users; insert audit records for modifications to original data by authorized, authenticated users. The master record can contain for example, roles and responsibilities, ticket/tower personnel credentials and other data, certification credentials and other data, mission data, applicant data, and geospatial data.

It is thought that the system and method of the present invention for verifying marine debris prior to removal and many of its attendant advantages will be understood from the foregoing description and it will be apparent that various changes may be made in the form, construction arrangement of parts thereof without departing from the spirit and scope of the invention or sacrificing all of its material advantages, the form hereinbefore described being merely a preferred or exemplary embodiment thereof.

What is claimed is:

1. A method of verifying marine debris recovery comprising:
Obtaining SONAR data related to the bottom of a body of water;
Processing said SONAR data to create processed SONAR data and to identify targets;
Obtaining position data related to said targets;
Populating an assessment database with said processed SONAR data, targets, and position data;
Providing a first time stamp to said assessment database;
Providing said assessment database to an off-site location for authentication;
Augmenting said assessment database with authentication data to create an authentication database comprising at least one authenticated target residing at an authenticated target site;
Providing a second time stamp to said authentication database;
Providing said authentication database to a removal ship, wherein based upon said authentication database said removal ship recovers said authenticated target from an authenticated target site;
Obtaining image recovery data, said image recovery data comprising at least one of:
a) an image of a recovered authenticated target or
b) an image of the authenticated target site following the removal of the recovered authenticated target;
Augmenting said authentication database with image recovery data to create a recovery database;
Providing a third time stamp to said recovery database;
Comparing the recovery database with the authentication database and storing the results in a verification database; and
Providing a fourth time stamp to the verification database.

2. The method of claim 1, said populating an assessment database further comprising:
Augmenting said assessment database with descriptors, wherein said descriptors are at least one of target dimensions, target coordinates, target images, or whether the target is a HAZMAT.

3. The method of claim 1, further comprising:
Creating a map from said assessment database.

4. The method of claim 1, said authentication data comprising buffer zones.

5. The method of claim 1, wherein said image recovery data further includes identification data.

6. The method of claim 1, wherein said verification database confirms whether or not only authenticated targets have been removed.

7. The method of claim 1, wherein said verification database confirms whether or not all authenticated targets have been removed.

8. The method of claim 1, wherein said processed SONAR data includes at least one of presence or absence of target(s) on the ocean or lake floor, measurement of sediments around detected target(s), dimensions of detected target(s).

9. The method of claim 8, further comprising augmenting said assessment database with at least one image of target(s), wherein said image is generated by a signal processing device.

10. The method of claim 9, wherein each said image is associated with position information generated by a positioning device.

11. A method of authenticating marine debris prior to recovery from a body of water comprising:
Obtaining SONAR data related to the bottom of said body of water;
Processing said SONAR data to create processed SONAR data and to identify targets;
Obtaining position data related to said targets;
Populating an assessment database with said processed SONAR data, targets, and position data;
Providing a first time stamp to said assessment database;
Providing said assessment database to an off-site location for authentication;
Augmenting said assessment database with authentication data to create an authentication database comprising at least one authenticated target residing at an authenticated target site;
Providing a second time stamp to said authentication database; and
Providing said authentication database to a removal ship, wherein based upon said authentication database said removal ship recovers said authenticated target from an authenticated target site.
